(19) United States
(12) Patent Application Publication
(10) Pub. No.: US 2019/0149181 A1
(43) Pub. Date: May 16, 2019

(54) FREQUENCY BAND SELECTION

(71) Applicant: HEWLETT-PACKARD DEVELOPMENT COMPANY, L.P., HOUSTON, TX (US)

(72) Inventor: MING-SHIEN TSAI, TAIPEI CITY (TW)

(21) Appl. No.: 16/092,965

(22) PCT Filed: Aug. 4, 2016
(86) PCT No.: PCT/US2016/045581

§ 371 Date: Oct. 11, 2018

(51) Int. Cl. H04B 1/10; H04B 17/318

(52) U.S. Cl. CPC H04B 1/1027; H04B 2001/1072; H04B 17/318

(57) ABSTRACT

Frequency band selection for tuning an antenna are disclosed. In one example, one of a Received Signal Strength Indicator (RSSI) value and an echo value of a plurality of frequency bands is obtained. Based on one of the RSSI values or the echo values of the frequency bands, a frequency band is selected. The selected frequency band is transmitted to a tuning component to tune the antenna of the electronic device.

### BACKGROUND

Electronic devices, such as cellular telephones and computers often contain tunable antennas which enable the electronic devices to select frequency bands to operate therewithin. In other words, the tunable antennas facilitate in dynamically modifying an operating frequency of the electronic device.

### BRIEF DESCRIPTION OF DRAWINGS

The following detailed description references the drawings, wherein:

FIG. 1A illustrates a block diagram of a system for selecting a frequency band to tune an antenna of an electronic device, according to an example implementation of the present subject matter.

FIG. 1B illustrates another block diagram of a system for selecting a frequency band to tune an antenna of an electronic device, according to an example implementation of the present subject matter.

FIG. 2A illustrates a method for selecting a frequency band to tune an antenna of an electronic device, according to an example implementation of the present subject matter.

FIG. 2B illustrates a method for selecting a frequency band to tune an antenna of an electronic device, according to another example implementation of the present subject matter.

FIG. 3 illustrates a computer readable medium storing instructions system for selecting a frequency band to tune an antenna of an electronic device, according to an example implementation of the present subject matter.

### DETAILED DESCRIPTION

Communication devices employ various tuning techniques for tuning an antenna. The tuning techniques enable the antenna to switch between channels that may be distributed over a wide range of frequency bands. In operation, a modem in a mobile communication device, such as a mobile phone, may identify a frequency band to tune the antenna based on the identified frequency band. The modem may then send instructions to a tuning circuit for tuning the antenna according to the identified frequency band.

As the mobile phone is equipped with a single modem which covers multiple frequency bands, the modem employs multiple components, such as oscillators. This results in the modem becoming large and complex. In addition, as mobile phones are primarily used for communication, the mobile phones have to employ such complex modems. Further, the modem performs various processing tasks which may correspond to different layers, such as a physical layer, of applicable protocols. As a result, existing tuning techniques put additional load on the modem.

Moreover, in response to various instructions sent by the modem, a large amount of data has to be processed at the physical layer. Data processing makes the physical layer complex. Any changes in the physical layer may not be cost efficient. Owing to these complexities in implementing the existing tuning techniques, tunable antennas may not be implemented for devices other than mobile phones. In order to implement the existing tuning techniques for other electronic devices, the modem may have to be re-configured which may put additional burden on mobile communication device manufacturers.

Approaches for selecting a frequency band for tuning an antenna of an electronic device are described herein. The present subject matter may include a system to select a frequency band for tuning an antenna of an electronic device. In one example, the system may include a processing unit, a receiver unit, a tuning component, and an antenna. In operation, the processing unit may obtain a Received Signal Strength Indicator (RSSI) value or an echo value for a plurality of frequency bands. In case the RSSI value or the echo value of any frequency band is more than a first threshold value, the processing unit may select the corresponding frequency band for tuning the antenna. In case the RSSI value or the echo value of any frequency band is less than the first threshold value, the processing unit may select a frequency band based on a region code of the electronic device. The selected frequency band is transmitted to the tuning component for tuning the antenna based on the selected frequency band.

In an example, the receiver unit may perform a polling operation to receive the plurality of frequency bands. In an aspect, the receiver unit may communicate with the antenna of the electronic device to receive the frequency bands. Further, the receiver unit may measure the RSSI value or the echo value for each of the plurality of frequency bands. Thereafter, the receiver unit may provide the measured values to the processing unit, such as a central processing unit (CPU) of the electronic device.

In an implementation, the processing unit may be configured to select a frequency band based on one of the RSSI value or the echo value. In an implementation, the processing unit may select the frequency band for which the RSSI value or the echo value is above the first threshold value. When the RSSI value or the echo value is below the first threshold value, the processing unit may select a frequency band based on a region code associated with the electronic device.

In another implementation, the processing unit may monitor the RSSI value or the echo value of the selected frequency band. When the RSSI value or the echo value of the selected frequency band goes below a second threshold value, the processing unit may send a notification to the receiver unit. The notification may include a request for sharing one of a current RSSI value or a current echo value of each of the frequency bands with the processing unit. Based on the notification, the receiver unit may share one of the current RSSI value or the current echo value of each of the frequency bands. The processing unit may then select another frequency band which has the RSSI value or the echo value above the first threshold value, to tune the antenna.

As the frequency band is selected by the processing unit based on the measured values or the region code, the modem may not be re-configured. Further, the processing unit may reduce the load on the modem thereby simplifying the physical layer implementation. The processing tasks related to selection and monitoring of frequency bands are performed by the processing unit, thus facilitating faster selection of the frequency bands. In addition, the above-described approach for selection of the frequency band may be utilized by mobile phones as well as other electronic devices.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

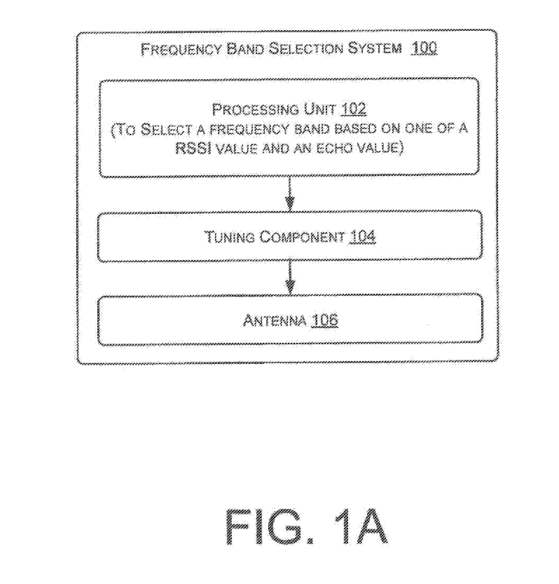

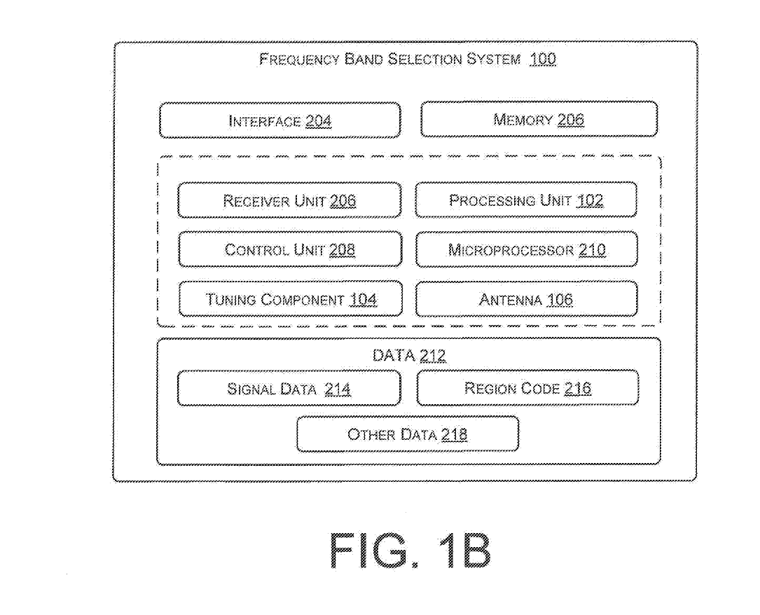

FIG. 1A illustrates a block diagram of a system 100, for selecting a frequency band to tune an antenna of an electronic device, according to an example implementation of the present subject matter. In one example, the system 100 may be implemented as any electronic device, such as a desktop, a laptop, a notebook computer, a tablet, a Personal Digital Assistant (PDA), a mobile phone, and the like. While the system 100 is shown as a separate system, the system 100 can be a part of an electronic device implementing a tunable antenna.

In one implementation, the system 100 includes a processing unit 102. The processing unit 102 may be implemented as microcomputers, microprocessors, microcontrollers, digital signal processors, central processing units, state machines, logic circuitries, and/or any other devices that manipulate signals and data based on computer-readable instructions. Further, functions of the various elements shown in FIG. 1A, including a functional block labeled as “processing unit”, may be provided through the use of dedicated hardware as well as hardware capable of executing computer-readable instructions. The system 100 further includes a tuning component 104 coupled to the processing unit 102.

The processing unit 102 obtains a Received Signal Strength Indicator (RSSI) value or an echo value pertaining to each of a plurality of frequency bands. The processing unit 102 selects a frequency band from the plurality of frequency bands based on either the RSSI values or the echo values. In an implementation, the processing unit 102 selects the frequency band having one of the RSSI value or the echo value above a first threshold value. For example, the processing unit 102 may select the frequency band for which the RSSI value or the echo value is above −70 dBm.

In another implementation, the processing unit 102 selects the frequency band based on a region code. For example, when the RSSI value or the echo value of each of the plurality of frequency bands is below the first threshold value, the processing unit 102 selects the frequency band based on the region code. In an example, information about a location of an electronic device may be obtained, such as by obtaining a region code associated with the electronic device. The location of the electronic device helps in determining a region in which the electronic device is operating. Based on the region, one or more frequency bands may be identified for tuning the antenna of the electronic device.

Thereafter, the processing unit 102 transmits the selected frequency band to the tuning component 104 to tune the antenna based on the selected frequency band. In an example, the processing unit 102 transmits a digital signal containing selected frequency band. The digital signal is converted into an analog signal before being shared with the tuning component 106. The tuning component 106 tunes the antenna 108 of the system 100. The processing unit 102 thereby performs most of the functions of a modem to facilitate in a simplified implementation of the physical layer. The processing unit 102 also enables mobile phones as well as other electronic devices to employ same antenna tuning technique.

The above aspects and further details are described in conjunction with FIG. 1B. FIG. 1B illustrates another block diagram of the system 100 for selecting a frequency band to tune the antenna 106 of an electronic device, according to an example implementation of the present subject matter. As mentioned previously, the system 100 may be implemented in various computing systems, such as personal computers, laptops, notebook computers, tablets, mobile phones, etc.

In an implementation, the system 100 includes the processing unit 102 and a memory 202 connected to the processing unit 102. Among other capabilities, the processing unit 102 may fetch and execute computer-readable instructions stored in the memory 202. The memory 202, communicatively coupled to the processing unit 102, can include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The system 100 also includes interface(s) 204. The interface(s) 204 may include data input and output devices, referred to as I/O devices. The interface(s) 204 facilitates the communication of the system 100 with various communication and computing devices and various communication networks, such as networks that use a variety of protocols, for example, Hypertext Transfer Protocol (HTTP) and Transmission Control Protocol/Internet Protocol (TCP/IP).

Further, in addition to the processing unit 102, the tuning component 104, and the antenna 106, the system 100 may include a receiver unit 206, a control unit 208, and a microprocessor 210. The system 100 may also include programs or coded instructions for supplementing the applications or functions performed by the above mentioned system components. The receiver unit 206, the control unit 208, the microprocessor 210, and the tuning component 104, amongst other things, include routines, programs, objects, components, and data structures, which perform particular tasks or implement particular abstract data types. The receiver unit 206, the control unit 208, the microprocessor 210, and the tuning component 104 may also be implemented as, signal processor(s), state machine(s), logic circuitries, and/or any other device or component that manipulates signals based on operational instructions. Further, the receiver unit 206, the control unit 208, the microprocessor 210, and the tuning component 104 can be implemented by hardware, by computer-readable instructions executed by the processing unit 102, or by a combination thereof.

In an example, the system 100 includes data 212. The data 212 may include signal data 214, region data 216, and other data 218. The other data 218 may include data generated and saved by the receiver unit 206, the control unit 208, the microprocessor 210, and the tuning component 104 for implementing various functionalities of the system 100.

In an implementation, the receiver unit 206 communicates with the antenna 106 of the system 100 to receive a plurality of frequency bands. In an example, the receiver unit 206 may be a modem or a transceiver. In an implementation, the processing unit 102 sends instructions to the tuning component 104 to enable the antenna to receive all frequency bands. Once the antenna 106 receives all frequency bands, the receiver unit 206 performs a polling operation to receive the frequency bands from the antenna 106. Further, the receiver unit 206 measures one of the RSSI value or the echo value pertaining to each of the plurality of frequency bands. In an example, the RSSI/echo values pertaining to each of the plurality of frequency bands may be stored as the signal data 214.

The receiver unit 206 provides the RSSI/echo values corresponding to each frequency band to the processing unit 102. In an aspect of the present subject matter, the processing unit 102 based on the received values, selects a frequency band for tuning the antenna 106. For example, when the RSSI value or the echo value of a frequency band is more than a first threshold value, say −70 dBm, the processing unit 102 may select the frequency band for tuning.

In another aspect of the present subject matter, when the RSSI value or the echo value of all the frequency bands is below the first threshold value, the processing unit 102 selects a frequency band for tuning the antenna 106 based on a region code associated with an electronic device implementing the system 100. As mentioned previously, a location of the electronic device facilitates in determining a region in which the electronic device is operating. For example, a global positioning system (GPS) of the electronic device may be used to determine the location of the electronic device.

Different regions are assigned different frequency bands of the radio frequency spectrum, for transmission and reception of signals. Accordingly, based on the region, the processing unit 102 may identify one or more frequency bands for tuning the antenna 106 of the electronic device, when the RSSI value or the echo value of each of the plurality of frequency bands is below −70 dBm. Information about the region of the electronic device may be stored as the region data 216. The information may include the location of the electronic device and available frequency bands in that location.

Once the frequency band is selected, the processing unit 102 transmits the selected frequency band to the tuning component 104 to tune the antenna 106 based on the selected frequency band. In an example implementation, the processing unit 102 sends instructions to the control unit 208 indicating that the selected frequency band is to be used as the frequency band for tuning the antenna 106. In an example, the control unit 208 receives the instructions from the processing unit 102 as a digital signal. The control unit 208 then forwards the instructions to the microprocessor 210. In the present example, the control unit 208 is an Embedded Controller or a Keyboard Controller. The control unit 208 may be configured to forward the digital signal containing instructions from the processing unit 102 to the microprocessor 210. In an example, the control unit 208 may communicate with the microprocessor 210 through a 3-wire Serial Peripheral Interface (SPI) bus.

The processing unit 102 may also directly communicate with the microprocessor 210 to tune the antenna 106 according to the selected frequency band. In an implementation, the microprocessor 210 converts the digital signal into an analog signal. Further, the microprocessor 210 provides the analog signal with the tuning component 104. In an example, the microprocessor 210 may communicate with the tuning component 104 through control voltage lines.

The tuning component 104 tunes the antenna 106 based on the selected frequency band. Accordingly, the electronic device implementing the system 100 receives signals associated with the selected frequency band.

In an implementation, once the antenna 106 is tuned as per the selected frequency band, the processing unit 102 may monitor the RSSI value or the echo value of the selected frequency band. In an example, the monitoring of the RSSI value or the echo value may be continuous, periodic, or at specified time interval. When the RSSI value or the echo value of the selected frequency band goes below a second threshold value, the processing unit 102 may send a notification to the receiver unit 206. In an example, the processing unit 102 may send the notification when the RSSI value or the echo value of the selected frequency band goes below −100 dBm. The notification may include a request for sharing one of a current RSSI value or a current echo value of each of the frequency bands with the processing unit 102.

Upon receiving the notification, the receiver unit 206 may again perform the polling operation to acquire all the frequency bands. Thereafter, the receiver unit 206 may measure the current RSSI value or the current echo value for each of the frequency bands. In response to the notification, the receiver unit 206 provides one of the current RSSI value or the current echo value of each of the frequency bands to the processing unit 102. The processing unit 102 may then select another frequency band which has the RSSI value or the echo value above the first threshold value, to tune the antenna 106.

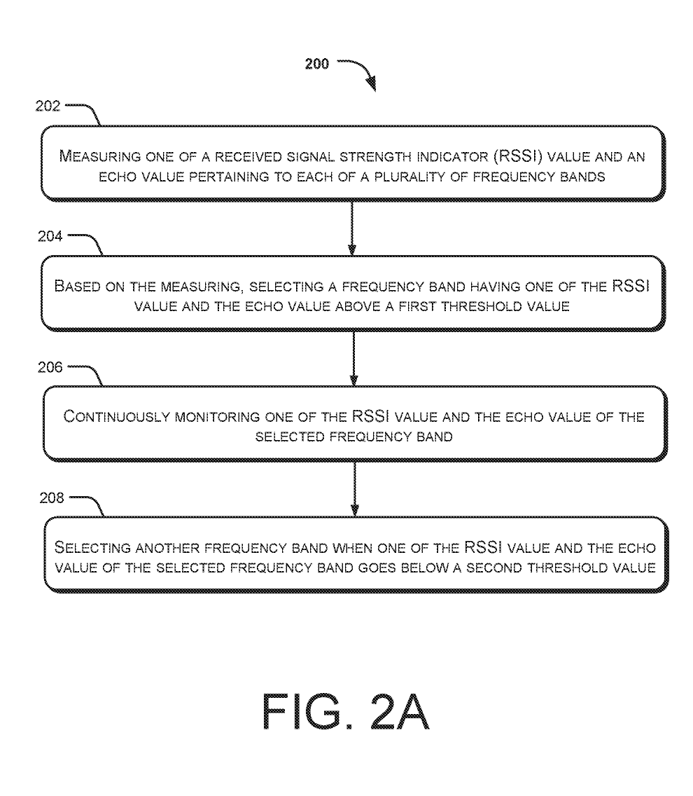

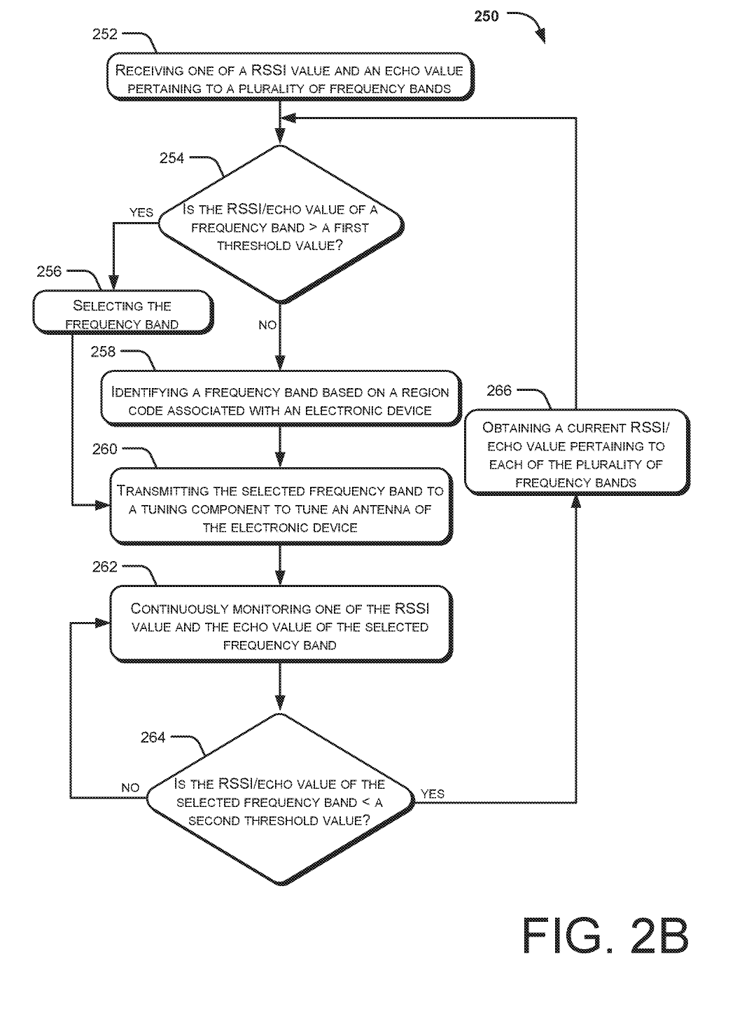

FIGS. 2A and 2B illustrate methods 200 and 250 for selecting a frequency band to tune an antenna 106, according to example implementations of the present subject matter. The order in which the methods 200 and 250 are described is not intended to be construed as a limitation, and some of the described method blocks can be combined in a different order to implement the methods 200 and 250, or an alternative method. Additionally, individual blocks may be deleted from the methods 200 and 250 without departing from the subject matter described herein. Furthermore, the methods 200 and 250 may be implemented in any suitable hardware, computer-readable instructions, or combination thereof.

The methods 200 and 250 may be performed by either a computing device under the instruction of machine executable instructions stored on a computer readable medium or by dedicated hardware circuits, microcontrollers, or logic circuits. Herein, some examples are also intended to cover computer readable medium, for example, digital data storage media, which are machine or computer readable and encode machine-executable or computer-executable instructions, where said instructions perform some or all of the steps of the described methods 200 and 250.

With reference to method 200 as depicted in FIG. 2A, at block 202, one of a Received Signal Strength Indicator (RSSI) value or an echo value pertaining to each of a plurality of frequency bands is measured. In an implementation, the receiver unit 206 measures the RSSI value or the echo value.

At block 204, based on the measured values, a frequency band having one of the RSSI value or the echo value above a first threshold value is selected. In an example implementation, when the RSSI value or the echo value of a frequency band is above −70 dBm, the processing unit 102 may select the frequency band for tuning the antenna 106 of the electronic device.

Further, at block 206, one of the RSSI value or the echo value of the selected frequency band is monitored. In an implementation, the processing unit 102 may monitor the RSSI value or the echo value of the selected frequency band. In an example, the processing unit 102 may continuously monitor the RSSI value or the echo value of the selected frequency band. In another example, the processing unit 102 may monitor the RSSI value or the echo value of the selected frequency band periodically or at specified time intervals.

At block 208, when the RSSI value or the echo value of the selected frequency band goes below a second threshold value, another frequency band is selected for tuning the antenna 106. In an example, the processing unit 102 may select another frequency band when one of the RSSI value or the echo value of the selected frequency band goes below −100 dBm.

Reference is now made to method 250 illustrated in FIG. 2B, as shown in block 252, one of a RSSI value or an echo value pertaining to a plurality of frequency bands is received. In an implementation, the processing unit 102 may receive one of the RSSI value or the echo value from the receiver unit 206.

At block 254, it is determined whether the RSSI value or the echo value of any of the frequency bands is greater than a first threshold value. In an implementation, the processing unit 102 may determine whether the RSSI value or the echo value of any of the frequency band is more than −70 dBm. If the RSSI value or the echo value is more than the first threshold value, the method 250 moves to block 256. If the RSSI value or the echo value is not more than the first threshold value, the method 250 moves to block 258.

At block 256, if the RSSI value or the echo value of any of the frequency bands is more than the first threshold value, the corresponding frequency band is selected for tuning the antenna 106. In an implementation, the processing unit 102 selects the frequency band for tuning the antenna 106.

At block 258, a frequency band based on a region code associated with an electronic device is selected. In an implementation, the processing unit 102 selects the frequency band based on the region code, when the RSSI value or the echo code is below the first threshold value. In an example, based on a location of the electronic device, the region code may be obtained.

At block 260, the selected frequency band is transmitted to a tuning component 104 to tune the antenna 106 of the electronic device. In an implementation, the processing unit 102 may transmit the selected frequency band in the form of a digital signal. The digital signal is then converted into an analog signal before reaching the tuning component 104.

At block 262, the RSSI value or the echo value of the selected frequency band is monitored. In an implementation, the processing unit 102 may monitor the RSSI value or the echo value of the selected frequency band. In an example, the processing unit 102 may continuously monitor the RSSI value or the echo value of the selected frequency band. In another example, the processing unit 102 may monitor the RSSI value or the echo value of the selected frequency band periodically or at specified time intervals.

At block 264, it is determined if the RSSI value or the echo value of the selected frequency band is lower than a second threshold value. In an implementation, the processing unit 102 may determine whether or not the RSSI value or the echo value of the selected frequency band has gone below the second threshold value, i.e., −100 dBm. If the RSSI value or the echo value is not more than the first threshold value, the method 250 goes back to block 262. If the RSSI value or the echo value is less than the second threshold value, the method 250 moves to block 266.

At block 266, a current RSSI value or a current echo value pertaining to each of the plurality of frequency bands is obtained. In an implementation, when the RSSI value or the echo value of the selected frequency band goes below −100 dBm, the processing unit 102 may send a notification to the receiver unit 206. The notification may include a request to provide the current RSSI value or the current echo value pertaining to each of the plurality of frequency bands.

Once the current RSSI value or the current echo value of each of the frequency bands is received, the method 250 goes back to block 254. Thus, the processing unit 102 selects the frequency band for tuning the antenna 106 of the electronic device. Thereby, the complexities in implementing the physical layer for tuning the antenna 106 are removed fr.

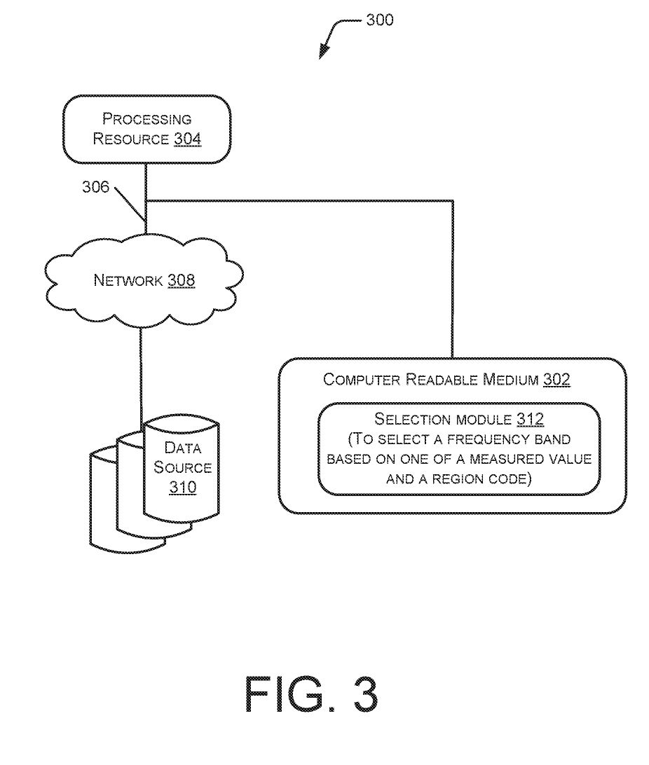

FIG. 3 illustrates an example system environment 300 using a non-transitory computer readable medium 302 for selecting a frequency band for tuning an antenna 106 of an electronic device, according to an example implementation of the present subject matter. The system environment 300 includes a processing resource 304 communicatively coupled to the non-transitory computer readable medium 302 through a communication link 306. In an example, the processing resource 304 can be a processing unit of a computing system, such as the system 100 for fetching and executing computer-readable instructions from the non-transitory computer-readable medium 302.

The non-transitory computer readable medium 302 can be, for example, an internal memory device or an external memory device. In one implementation, the communication link 306 may be a direct communication link, such as one formed through a memory read/write interface. In another implementation, the communication link 306 may be an indirect communication link, such as one formed through a network interface. In such a case, the processing resource 304 can access the non-transitory computer readable medium 302 through a communication network (not shown).

The processing resource 304 and the non-transitory computer readable medium 302 may also be communicatively coupled to data source 308. The data source 308 can include, for example, a receiver unit. In an example implementation, the non-transitory computer readable medium 302 includes a set of computer readable instructions frequency band selection. The set of computer readable instructions, referred to as instructions hereinafter, can be accessed by the processing resource 304 through the communication link 306 and subsequently executed to perform acts for frequency band selection.

Referring to FIG. 3, in an example, the non-transitory computer-readable medium 302 may include instructions 310 to receive values pertaining to a Received Signal Strength Indicator (RSSI) or an echo for each of the plurality of frequency bands. The non-transitory computer-readable medium 302 may include instructions 312 to select a frequency band for tuning the antenna 106 of the electronic device, based on one of the measured values or a region code associated with the electronic device. In an implementation, when the RSSI value or the echo value is below a first threshold value, i.e., −70 dBm, the frequency band may be selected based on the region code.

The non-transitory computer-readable medium 302 may include instructions 314 to transmit a digital signal containing the selected frequency band to tune the antenna 106. In an example, the digital signal is converted into an analog signal. Thereafter, the analog signal containing the selected frequency band is provided to the tuning component 104 to tune the antenna 106 based on the selected frequency band.

Further, in an example implementation, the non-transitory computer-readable medium 302 may include instructions to monitor one of the RSSI value or the echo value of the selected frequency band. In an example, the monitoring of the RSSI value or the echo value of the selected frequency band may be continuous, periodic, or at specified time intervals.

Further, in an example implementation, the non-transitory computer-readable medium 302 may include instructions to send a notification to the receiver unit 206, when the RSSI value or the echo value of the selected frequency band goes below a second threshold value. In the present example, when the RSSI value or the echo value of the selected frequency band goes below −100 dBm, the notification may be sent to the receiver unit 206. The notification may include a request to share a current RSSI value or a current echo value of each of the frequency bands. Accordingly, based on the current RSSI value or the current echo value, another frequency band may be selected to tune the antenna 106 as per the another frequency band.

Although implementations of selecting a frequency band for tuning an antenna of an electronic device have been described in language specific to structural features and/or methods, it is to be understood that the present subject matter is not necessarily limited to the specific features or methods described. Rather, the specific features and methods are disclosed and explained in the context of a few implementations for selecting a frequency band for tuning an antenna of an electronic device.

I/We claim:

1. A system to select a frequency band for tuning an antenna of an electronic device, the system comprising:
a processing unit to,
obtain one of a Received Signal Strength Indicator (RSSI) value and an echo value pertaining to each of a plurality of frequency bands;
select a frequency band from the plurality of frequency bands based on one of the RSSI value and the echo value; and
transmit the selected frequency band to a tuning component to tune the antenna based on the selected frequency band.

2. The system as claimed in claim 1, wherein the processing unit is to select the frequency band having one of the RSSI value and the echo value above a first threshold value.

3. The system as claimed in claim 1, wherein the processing unit is to select the frequency band based on a region code, when one of the RSSI value and the echo value is below a first threshold value.

4. The system as claimed in claim 1 further comprises a receiver unit coupled to the processing unit, to,
communicate with the antenna to receive the plurality of frequency bands; and
measure at least one of the RSSI value and the echo value of each of the plurality of frequency bands.

5. The system as claimed in claim 4, wherein the processing unit is to,
monitor one of the RSSI value and the echo value of the selected frequency band; and
when one of the RSSI value and the echo value of the selected frequency band goes below a second threshold value, send a notification to the receiver unit to share one of a current RSSI value and a current echo value pertaining to each of the plurality of frequency bands.

6. The system as claimed in claim 5, wherein one of the RSSI value and the echo value of the selected frequency band is monitored continuously, periodically, and at a specified time interval.

7. The system as claimed in claim 1 further comprises a control unit, coupled to the processing unit, to
receive, from the processing unit, instructions indicating the selected frequency band to be used as the frequency band by the tuning component; and
forward the instructions to the tuning component.

8. A method for selecting a frequency band for tuning an antenna of an electronic device, the method comprising:
measuring, by a receiver unit, a Received Signal Strength Indicator (RSSI) value and an echo value pertaining to each of a plurality of frequency bands;
based on the measuring, selecting, by a processing unit, a frequency band having one of the RSSI value and the echo value above a first threshold value, wherein the selecting comprises;
monitoring one of the RSSI value and the echo value of the selected frequency band; and
selecting another frequency band when one of the RSSI value and the echo value of the selected frequency band goes below a second threshold value.

9. The method as claimed in claim 8 further comprising transmitting, by the processing unit, the selected frequency band to a tuning component for tuning the antenna based on the selected frequency band.

10. The method as claimed in claim 8, wherein the selecting comprises receiving, from the receiver unit, one of a current RSSI value and a current echo value pertaining to each of the plurality of frequency bands, when one of the RSSI value and the echo value of the selected frequency band goes below the second threshold value.

11. The method as claimed in claim 8, wherein the selecting comprises obtaining a frequency band based on a region code of the electronic device, when one of the RSSI value and the echo value goes below the first threshold value.

12. The method as claimed in claim 8, wherein the transmitting comprising:
converting a digital signal containing information pertaining to the selected frequency band, into an analog signal; and
providing the analog signal to the tuning component to tune the antenna.

13. A non-transitory computer-readable medium having a set of computer readable instructions that, when executed, cause a processing unit to,
receive values pertaining to one of a Received Signal Strength Indicator (RSSI) and an echo for each of the plurality of frequency bands;
select a frequency band based on one of the measured values and a region code, wherein when any of the measured values is below a first threshold value, a frequency band based on the region code is selected;
transmit a digital signal containing the selected frequency band to tune an antenna, wherein the digital signal is converted into an analog signal and provided to a tuning component to tune the antenna based on the selected frequency band.

14. The non-transitory computer-readable medium as claimed in claim 13, wherein the computer readable instructions, when executed, further cause the processing unit to,
monitor one of the RSSI value and the echo value of the selected frequency band; and
send a notification to the receiver unit to share one a current RSSI value and the echo value pertaining to each of the plurality of frequency bands, when one of the RSSI value and the echo value of the selected frequency band goes below a second threshold value.

15. The non-transitory computer-readable medium as claimed in claim 14, wherein the computer readable instructions, when executed, further cause the processing unit to select another frequency band for tuning the antenna, when one of the RSSI value and the echo value of the selected frequency band goes below the second threshold value.
